(19) United States
(12) Patent Application Publication
(10) Pub. No.: US 2016/0142462 A1
(43) Pub. Date: May 19, 2016

(54) Displaying Identities of Online Conference Participants at a Multi-Participant Location

(71) Applicant: CISCO TECHNOLOGY, INC., San Jose, CA (US)

(72) Inventors: Jay K. Johnston, Raleigh, NC (US); David C. White, JR., Durham, NC (US)

(21) Appl. No.: 14/547,763

(22) Filed: Nov. 19, 2014

(51) Int. Cl. H04L 29/06; G10L 17/00

(52) U.S. Cl. CPC H04L 65/604; H04L 65/403; H04L 65/4015; G10L 17/005

(57) ABSTRACT

Techniques are presented herein to visually display who is speaking when an online conference session is established involving participants at multiple locations. When it is determined that there are multiple participants of the online conference session at a first location at which one or more microphones can detect audio from the multiple participants, a visual indicator of the first location is generated for display to the participants in the online conference session. In addition, in a predetermined relationship with the visual indicator of the first location, identifiers of the multiple participants at the first location are generated that can also be displayed to the participants in the online conference session.

### TECHNICAL FIELD

The present disclosure relates to online conference systems.

### BACKGROUND

Online conference systems are increasingly used not only for audio or voice meeting conferences, but also for screen sharing sessions. In such online conference systems, participants can all view an application or a desktop which is being shared by a user. In these cases, most (if not all) attendees are not only dialed into (or otherwise hearing the audio of the conference) but they are also connected to the conference server with their computer, tablet or mobile device. Some participants of a conference session may meet in one particular location to attend the conference session; other participants may connect to the conference session from remote locations. In some cases, several meeting participants may gather in a conference room in which there are one or more microphones installed and connect to the conference server by a dial-in connection using a conference phone in the conference room. Participants who connect to the conference session from other locations can only hear a speaker's voice, but cannot easily determine which of the participants in the large conference room is speaking at any given time.

When some of the in-room participants of the conference session are not very close to an in-room microphone in the conference room, they cannot be heard clearly by the remote participants. In addition, it may be impossible for the remote participants to determine who is actually speaking. As a consequence, remote dial-in participants may often interrupt the voice meeting conference and ask the speaker to identify themselves and/or to move closer to an in-room microphone.

### BRIEF DESCRIPTION OF THE DRAWINGS

FIG. 1 is a block diagram illustrating an online conference system according to an example embodiment.

FIG. 2 is a diagram illustrating participants who are determined to be a multi-participant location are identified in a user interface to remote participants, and how an indication of who is speaking in the multi-participant location may be displayed, according to an example embodiment.

FIG. 3 is a flow chart depicting operations performed by a conference server when a new participant joins a conference session to determine whether that new participant is located in the same conference room as other participants, according to an example embodiment.

FIG. 4 is a flow chart depicting operations performed by the conference server to determine which participant in the multi-participant conference room location is speaking during the conference session, according to an example embodiment.

FIG. 5 is a flow chart depicting operations performed by the conference server to indicate how the best microphone for a participant is selected, according to an example embodiment.

FIG. 6 is a high level flow chart depicting operations performed by the conference server, according to an example embodiment.

FIG. 7 is a block diagram illustrating the configuration of a conference server according to an example embodiment.

### DESCRIPTION OF EXAMPLE EMBODIMENTS

### Overview

Techniques are presented herein to improve the user experience during an online conference session by automatically detecting and aggregating (in a visual way) those users attending the online conference session who are determined to be in the same room as other attendees of the same online conference session. A conference server establishes an online conference session that involves participants at multiple locations. When it is determined that there are multiple participants of the online conference session at a first location, a visual indicator of the first location is generated for display to the participants in the online conference session. This visual indicator displays a grouping of those individuals who are determined to be participating in the online conference session, and located in the same physical location. In addition, in a predetermined relationship with the visual indicator of the first location, identifiers of the multiple participants at the first location are generated that can also be displayed to the participants in the online conference session.

### Example Embodiments

The experience of a remote attendee/participant of an online conference with multiple participants who are physically located in the same room can be greatly improved by automatically detecting, grouping and displaying a visual indicator identifying participants that are located in the same physical location (e.g., a conference room) and identifying the participant who is currently speaking when that person is co-located with other conference participants in the same location all sharing the same dial-in line. The terms “attendees” and “participants” are used interchangeable herein.

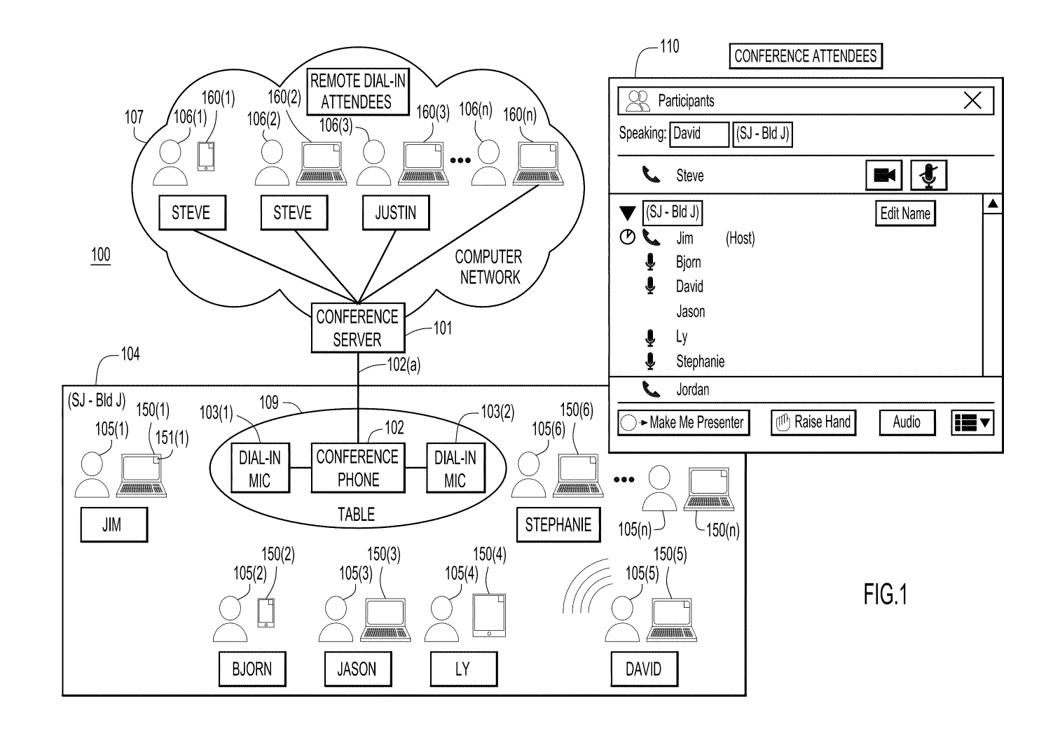

FIG. 1 is a block diagram illustrating a conference system 100 configured to execute the techniques discussed below in detail to improve the user experience of a remote conference participant presented herein. The conference system 100 includes a conference server 101, user devices 160(1)-160(n) of a plurality of remote participants 106(1)-106(n) connected to conference server 101 via network 107, and a conference phone 102 connected to conference server 101 via dial-in phone connection logically depicted at reference numeral 102(a). The conference server 101 is configured to establish and support a web-based (online) conferencing and collaboration.

One or more microphones may be connected to conference phone 102 which are commonly used by all local participants of the conference session in a conference room 104. In the example embodiment depicted in FIG. 1, participants 105(1)-105(n) are all located in conference room 104 described as “SJ-Bld J”. There are microphones 103(1) and 103(2) associated with the conference phone to detect audio from the participants on the conference room 104. Microphones 103(1) and 103(2) are placed apart from each other on table 109 and are connected to conference phone 102.

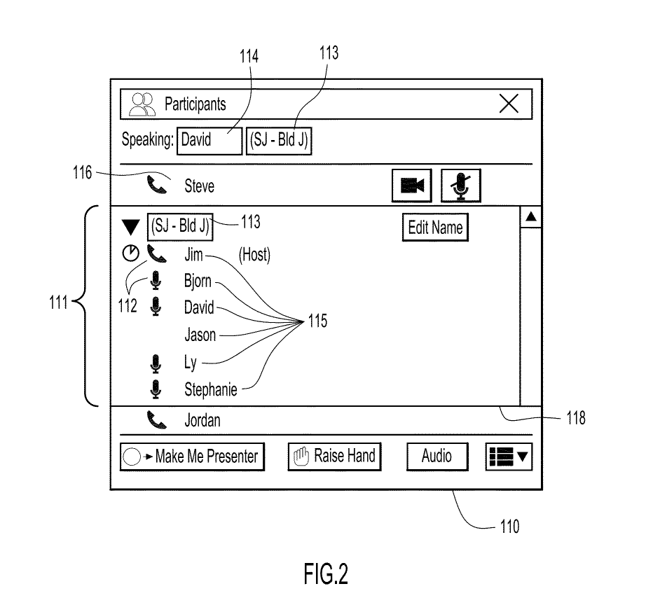

The conference server 101 is configured to establish and support a web-based (online) conferencing and collaboration system. As shown in FIG. 1, participants 105(1)-105(n) may have their own personal user devices 150(1)-150(n). Examples of personal user devices are, but not limited to, laptops, tablets or smartphones. All conference participants may use their user devices to display information about the conference session. In particular, the conference server 101 may generate a conference attendees window 110 (also depicted in FIG. 2 in greater detail) for display on a display screen of the user devices for any of the participants on a conference session.

When multiple conference participants are in the same room during a conference session, all sharing a single dial-in voice line, such as dial-in connection 102(a) for conference room 104 in FIG. 1, it is difficult or impossible for a remote conference participant to know which participants are co-located in the same conference room. This is further complicated when multiple “shared rooms” are joined to the same conference session. Conventional conferencing systems always indicate that the person who joined the conference and initiated the dial-in line for the shared room is the one currently speaking. This is often incorrect and misleading to the participants not located in that room who are connected to the meeting. The remote participants cannot determine who (and with what title/position) in conference room is currently speaking Therefore, remote participants often have to ask for the speakers in the multi-participant room to identify themselves. In addition, conference rooms can have large tables and attendees are spread throughout the room, often too far away from the dial-in phone to provide high-quality audio when they speak. Remote users often have to ask for the person to move closer to the dial-in phone or speak louder.

Returning to the specific example of FIG. 1, all user devices 150(1)-150(n) may have a built-in microphone (not shown) or a directly connected microphone, such as a microphone and earpiece/headphone that connects to the user device by Universal Serial Bus). The built-in microphones on the user devices can be used in many ways. In one example, the built-in microphones of the user devices (user devices 150(1)-150(n)) may be used to obtain a unique audio stream from each user device. Software (and/or hardware) on conference server 101 analyzes these audio streams against each other, as well as against audio received on all dial-in connections or any other audio input. The audio streams are continuously sampled, and those streams who share the same audio are grouped together, representing users who are in the same location, i.e., within the same room during a conference session.

Attendee 105(1) (Jim) may be located in conference room 104 (“SJ-Bld J”) and may have used conference phone 102 to connect to an online conference session. Conference phone 102 is a dial-in phone having connected thereto microphones 103(1) and 103(2). In addition, attendee 105(2) (Bjorn), attendee 105(3) (Jason), attendee 105(4) (Ly), attendee 105(5) (David), and attendee 105(n) (Stephanie) are also attending the conference in conference room 104. In the specific example of FIG. 1, audio streams of all personal computing devices 150(1)-150(n) in conference room 104 are analyzed against each other and against the audio stream received from microphones 103(1) and 103(2). By continuously sampling and analyzing these audio streams, the conference server 101 determines that attendee 105(1) (Jim), attendee 105(2) (Bjorn), attendee 105(4) (Ly), attendee 105(5) (David), and attendee 105(6) (Stephanie) are in the same location, namely, in conference room 104. The conference server 101 groups the attendees together and displays such grouping in a conference attendees window 110.

Typically, user devices have a microphone, such as microphone 151(1) shown on Jim's user device 150(1). Several of the other user devices have microphones but for simplicity in the figure, reference numerals are not provided for microphones on all the user devices. However, the user device of a participant also may not have a microphone or the microphone of the user device may be disabled and/or not functioning. When a participant (e.g., attendee 105(3) (Jason)) is attending the conference in conference room 104 and her/his user device (e.g., user device 150(3)) does not have a microphone or the microphone is disabled and/or not functioning, conference server 101 cannot automatically determine that the participant (attendee 105(3) (Jason) is attending the conference in conference room 104. In this case, the participant's name can be manually associated with conference room 104.

For example, attendee 105(3) (Jason), or any other attendee, may manually move Jason's name by dragging it and placing it in the conference attendees window 110 associated with room name indicator 113 thereby indicating that Jason is attending the conference in conference room 104. In other words, the conference server 101 may receive a command (from any participant, host, etc.) to change display of a particular participant that is not displayed as being at a particular location so that the particular participant is displayed as being at that location (after the conference server 101 processes the command). The command may take the form of movement of the name in the conference attendees window 110 (by a mouse or other pointer or gesture).

The conference attendees window 110 is shown in greater detail in FIG. 2. Conference attendees window 110 includes a visual location indicator 111, microphone type indicators 112, room name indicator 113, a speaking participant indicator 114, a name indicator or participant identifier 115 for each participant that is determined to be in the conference room location associated with the room name indicator 113, and a current user indicator 116 indicating on whose user device the conference attendees window 110 is being displayed.

As shown in FIG. 2, speaking participant indicator 114 indicates that David is currently speaking. The room name indicator 113 (e.g., “SJ-Bld J”) for the location where David is located is displayed next to the speaking participant indicator 114.

The participant identifiers 115 for each participant determined to be in the conference room location associated with room name indicator 113 may be presented in a list format (e.g., Jim, Bjorn, David, Jason, Ly, Stephanie) surrounded by solid line 118 of visual location indicator 111. In addition, the area inside solid line 118 may be shaded or otherwise highlighted to further indicate that these participants are in conference room location 104 (“SJ-Bld J”). By providing visual location indicator 111 of participants detected to be in conference room location 104, remote dial-in attendee 106(1) (Steve) (and other remote participants) can easily determine which of the participants is in conference room location 104 associated with room name indicator 113. In the specific example of FIG. 2, room name indicator 113 indicates that location 104 is conference room “SJ-Bld J.” This room/location name can be changed/edited by the user to which conference attendees window 110 is shown and/or by the meeting host (Jim, in this example).

Next to each participant identifier 115, microphone type indicators 112 may be displayed. In the specific example of FIG. 2, microphone type indicator 112 next to participant Jim indicates that participant Jim has joined the meeting (as host) and used dial-in connection 102(a) from conference room 104 to connect to the conference session.

Microphone type indicators next to Bjorn, David, Ly, and Stephanie indicate that these participants attend the conference with their user devices which have built-in microphones. In addition to speaking participant indicator 114, the microphone type indicator 112 next to David also includes two or more curved lines above it to indicate that participant David is currently speaking.

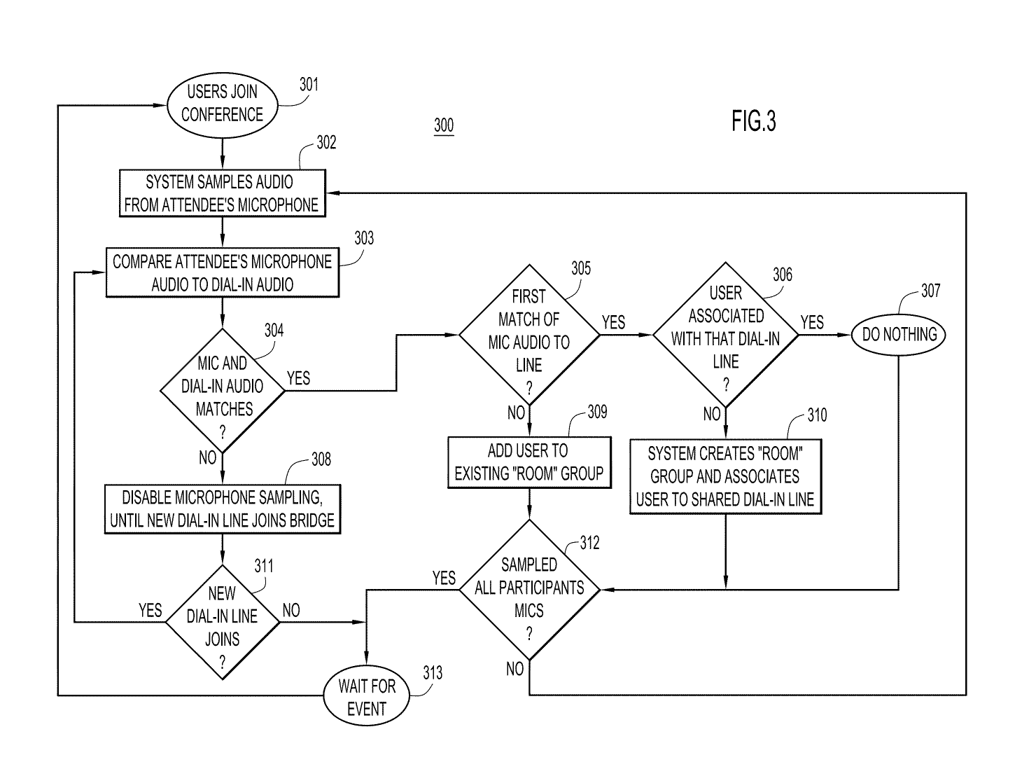

Reference is now made to FIG. 3 (with continued reference to FIG. 1) for description of a method 300 of operations performed by the conference server 101 pursuant to the techniques presented herein. Method 300 begins at 301, where a user (or new attendee/participant) with his/her user device joins a conference session administered by the conference server 101.

At 302, the built-in microphone of the new attendee's user device (laptop, smartphone, tablet, etc.) is leveraged to obtain a unique audio stream from the user device. The unique audio stream is sampled within the 24 critical frequency bands, for example, and at 303, the audio stream of the new attendee's user device is compared to an audio stream of local dial-in audio, commonly received from a conference room location having a conference phone with a built-in microphone and possibly one or more microphones positioned around the conference room or table in a conference room. In other words, the conference server 101 compares the audio captured by the microphone of the user device of the new participant with audio received from a microphone at conference room 104 via dial-in phone connection 102(a) to generate a comparison result. If there are multiple dial-in connections to the conference session, then the conference server 101 would compare the audio stream captured by the microphone on the user's device with the audio stream for each dial-in connection until a match is determined (as described further below).

At 304, when it is determined that the audio captured by the built-in microphone of the user device of the new participant does not match with the audio received from a dial-in connection, (e.g., dial-in 102(a) of conference room 104), the conference server 101 determines that the new participant is not located in conference room location 104. The conference server 101 displays to participants in the online conference session an indication that the device of the new participant is at a location different from the conference room location 104, and at 308, the conference server disables audio sampling of audio received from the microphone of the user device of the new participant.

At 311, when the conference server 101 determines that another new participant joins the conference session, processing returns to 303 where a comparison of the audio stream of the other new attendee's user device with the audio stream(s) of dial-in connection(s). When there is no further new participant joining the conference session, at 313 the conference server waits for the next event.

When it is determined at 304 that the audio stream from a microphone of the user device of the new participant matches with the audio received from a dial-in connection, e.g., from audio captured by microphone 103(1) or 103(2) at conference room location 104 (304: YES), at 305, the conference server 101 determines whether the audio stream from the microphone of the user device of the new participant is the first audio stream that matches the audio stream from a dial-in connection, e.g., of dial-in microphone 103(1) or 103(2). If the conference server 101 determines that the audio stream from the microphone of the user device of the new participant is not the first audio stream that matches the audio stream from a dial-in connection e.g., dial-in microphone 103(1) or 103(2), it is determined that a ‘room’ group of participants already exists. At 309, the conference server 101 associates the new participant with that corresponding room location, e.g., conference room location 104, by adding the new participant to an existing room group thereby indicating that the new participant is located in/at that location, e.g., in conference room location 104. In addition, an indication that the device of the new participant is in/at that location, e.g., conference room location 104, is displayed to all participants in the online conference session.

In other words, once individual audio sources have been identified as transmitting the same audio to the conferencing server, the conference server groups those streams (and thus those individuals) together thereby indicating that the individuals are in the same physical location. A visual indication of this audio grouping appears on the user interface (for example in conference attendees window 110). Continuous sampling allows the conference server 101 to detect any changes to this group, for instance, if a user joins or leaves a room.

It is also possible, that the new participant is a first attendee at a particular location e.g., conference room location 104. In this case, a room group does not yet exist. Accordingly, if the conference server determines at 305 that the audio stream from the new participant is a first match with the audio stream from a dial-in connection (305: YES), upon determining at 306 that the new participant is not yet associated with an existing dial-in connection 102(a), at 310, the conference server 101 creates a room group for that dial-in phone connection and associates the new participant with the room group for that dial-in phone connection.

If the audio stream from the new participant is a first match with the audio stream from an existing dial-in connection and if the new participant is already associated with an existing dial-in connection, no further grouping operations are necessary as shown at 307 and processing goes to 312 at which it is determined whether all participants' user devices' microphones have been sampled. Processing then repeats from 302 if there are additional audio streams from microphones of user devices to be analyzed.

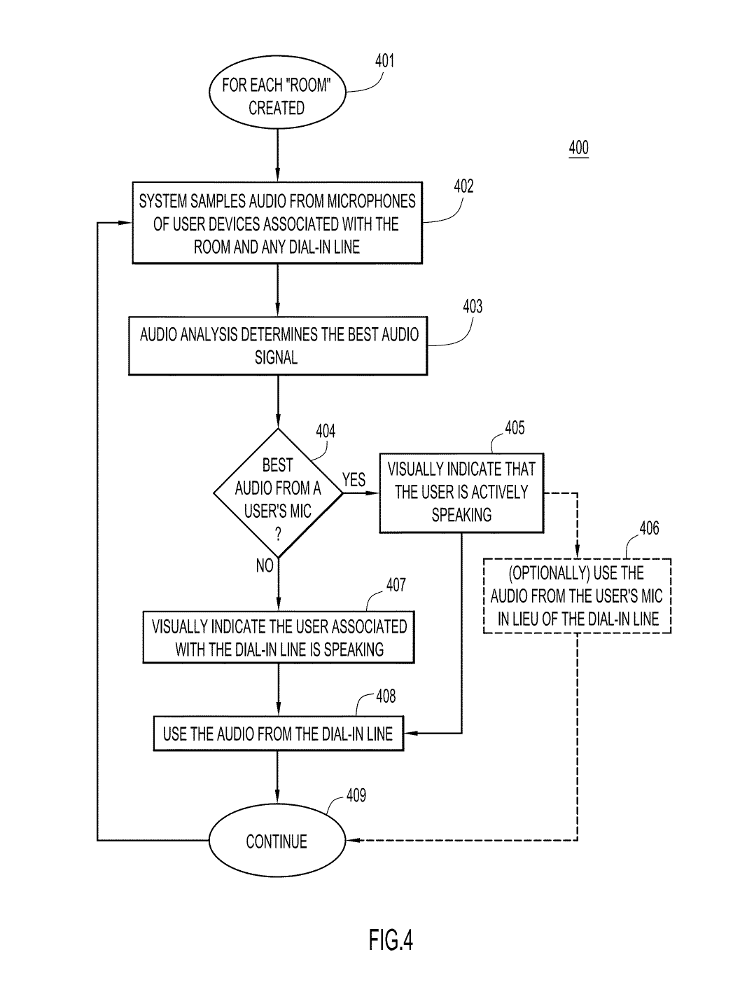

Referring now to FIG. 4, a flow chart is described for a process to determine which conference attendee/participant is speaking. As described above in connection with FIG. 1, there may be multiple physical locations from which participants connect to the conference session. Method 400 is performed for each location for which a ‘room’ group of multiple participants has been created (because multiple participants at that location have been detected). Moreover, method 400 is performed to determine a current speaker in each multiple participant location. The method begins at 401 for a multi-participant location (room′ group). At 402, the conference server 101 samples audio from all microphones of the user devices of all attendees associated with a given multi-participant physical location, e.g., conference room location 104, and any dial-in connection for that location.

At 403, conference server 101 determines the best audio signal. If at 404 it is determined, that the best audio sample (determined at 403) originates from a microphone of an attendee's user device (and not from one of the dial-in connection microphones) the conference server 101 indicates at 405 that the attendee, associated with the user device from which the best audio sample is obtained, is the current active speaker. The “best” audio signal may be one that has the best overall quality, best signal strength, or satisfy any one or more other attributes.

Although the user device microphone is used to determine who is currently speaking, the audio signal from the user device microphone may not be used (or played) to the other participants for the conference session. Instead, as shown at 408, the conference server 101 uses the audio signal from the dial-in connection may be used. However, this is not meant to be limiting. At 406, the conference server 101 may optionally use the audio signal from the microphone of the user device of the current speaker instead of the audio signal from the dial-in connection.

In other words, with multiple audio sources identified to be coming from the same location, continuous sampling and analysis is done on each of the audio streams to select the “best” one, and this stream is utilized and transmitted to all other conference participants which are not in that same location.

Once users have been determined to be in the same location, if multiple microphones pick up different audio streams (representing the fact that more than one person in the room is talking at the same time), then more than one audio stream may be transmitted to all other conference attendees in an effort to improve audio quality. An indication of the microphones which are being selected for use by the conference server 100 may be visually displayed.

In the context of the example shown in FIGS. 1 and 2, the conference server 101 samples all audio streams from all participant user devices, and compares it to the audio stream from the dial-in line 102(a) for conference room 104. When the signal-to-noise ratio is higher from one of the user device microphones in the room, a visual indicator is displayed in the user interface (conference attendees window 110) indicating which user in the room is speaking. This is displayed to all conference participants. During this time, no audio is transmitted from the other microphones in the same room, if only one person in that room is speaking. If multiple participants are speaking simultaneously, the conference server 101 will generate a visual indication that each of multiple participants are speaking simultaneously.

Still referring to FIG. 4, if it is determined at 404 that the best audio signal is not received from any user device microphone, at 407, the conference server 101 visually indicates that the user associated with the dial-in line is currently speaking (e.g., Jim, in the example of FIG. 2). At 408, the conference server 101 uses the audio signal from the dial-in connection for the conference session. At 409, method 400 returns to 402 thereby providing a continuous sampling process.

Thus, to summarize the operations of FIG. 4, for a participant who is determined to be speaking at a particular location, a determination is made as to whether best audio for the participant is from the one or more microphones at the particular location or the microphone of the user device of the participant. When it is determined that the best audio is from the microphone of the user device for the participant at the particular location, the conference server generates for display an indicator that indicates which of the multiple participants at the particular location is/are speaking.

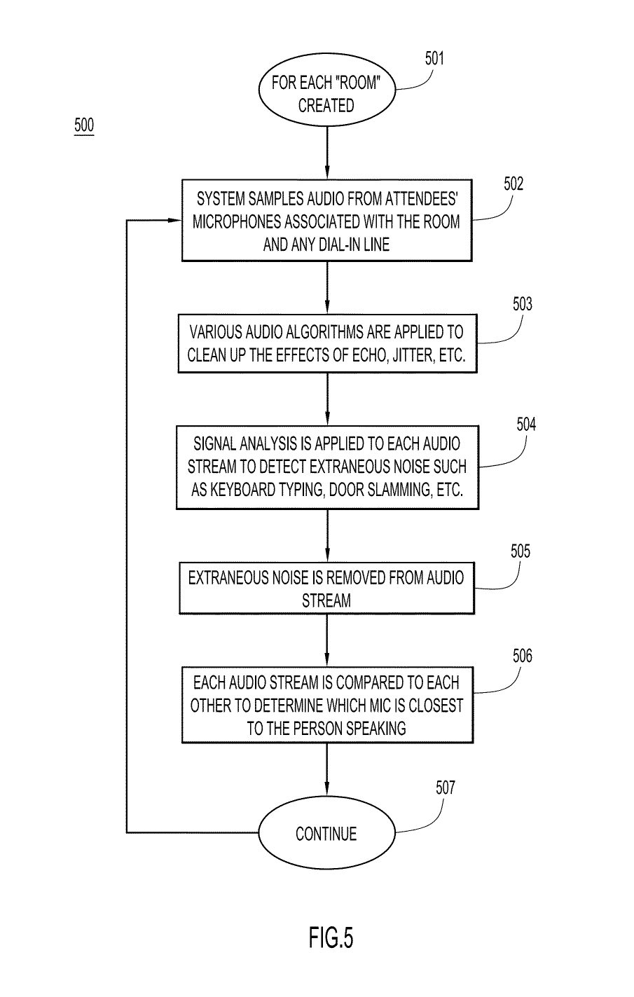

Reference is now made to FIG. 5 which illustrates a flow chart for a method 500 for choosing the best microphone for audio during a conference session. Method 500 is performed for each multi-participant ‘room’ group that has been created.

Method 500 begins at 501 and is performed for each location such as conference room location 104 shown in FIG. 1. At 502, the conference server 101 samples audio from user device microphones of all attendees/participants associated with the physical location and with any dial-in line.

At 503, the conference server 101 applies various audio algorithms to the audio streams from the user device microphones to remove effects of echo, jitter, etc.

At 504, signal analysis is applied to each audio stream to detect extraneous noise such as keyboard typing, door stemming, etc.

At 505, the detected extraneous noise is removed from the audio streams, and at 506, each audio stream is compared to each other to determine which microphone is closest to the person currently speaking. The microphone that is determined to be the closest is the one selected for use for that ‘room’ group.

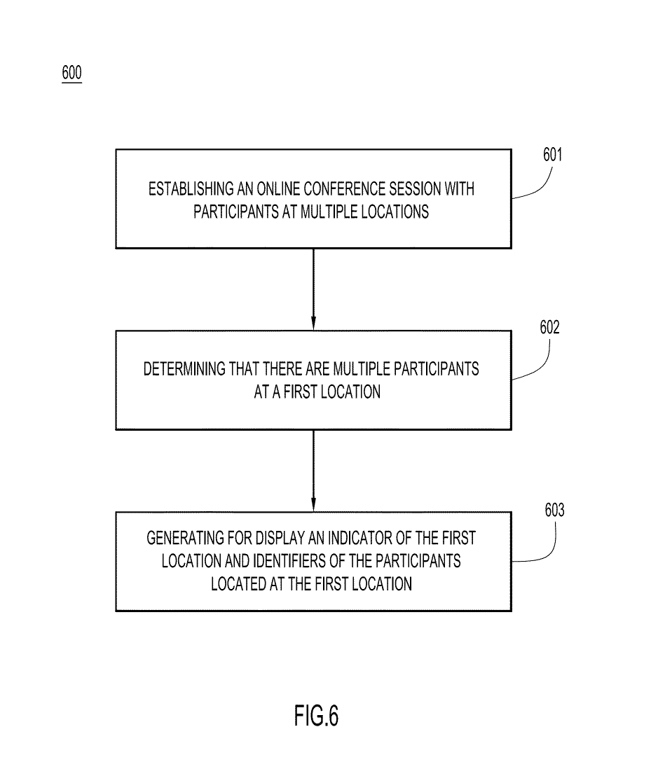

Reference is now made to FIG. 6. FIG. 6 is a high level flow chart that summarizes the operations performed at the conference server in accordance with the techniques presented herein. Method 600 generates an indicator of a conference location and identifiers of participants located at the conference location. That is, method 600 illustrates how participants of conference session are informed about which of the participants of the conference session is at a specific location. Method 600 begins at 601 where conference server 101 establishes an online conference session with participants at multiple physical locations. At 602, the conference server 101 determines that there are multiple participants at a first location at which one or more microphones can detect audio from the multiple participants. At 603, conference server 101 generates for display an indicator of the first location and identifiers of the participants at the first location. More specifically, the conference server generates for display to participants in the online conference session a visual indicator of the first location and in a predetermined relationship with the visual indicator of the first location, identifiers of the multiple participants at the first location.

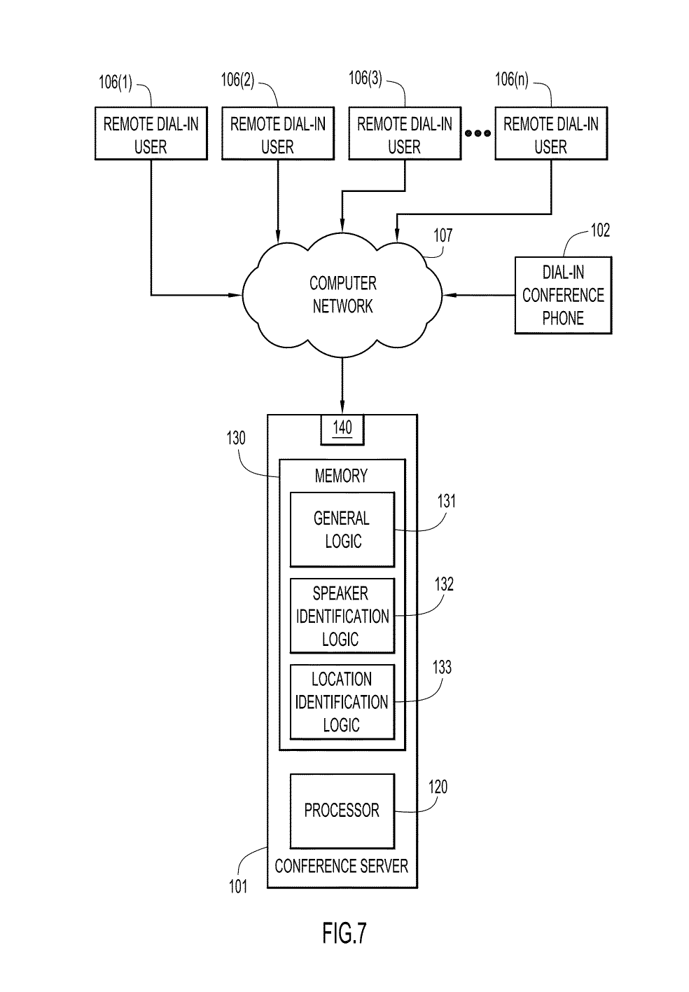

Reference is now made to FIG. 7. FIG. 7 illustrates a block diagram of conference server 101 that, as described with regard to FIG. 1, is configured to execute conference system techniques to improve an experience of remote attendees of an audio conference with multiple participants who are physically located in the same room. Merely for ease of illustration, the conference system techniques presented herein are described with reference to a single server 101. It is to be appreciated that, in practice, due to the complexity of remote audio conferences, a plurality of servers or other devices may be utilized to establish and maintain an online conference session, to determine which of the participants is in a physical location and who is currently speaking. Moreover, the operations of the conference server 101 may be performed by one or more applications running in a cloud computing system.

Conference server 101 includes a processor 120, memory 130, and one or more network interface units 140. The network interface unit(s) 140 enables network communication on behalf of the conference server 101. Memory 130 stores general control logic 131, speaker identification logic 132 and location identification logic 133. The general control logic 131 is software that enables the conference server to establish and maintain a conference session, including the processing of audio and video received from participant devices and dial-in connections, and the re-distribution of audio and video to the participant devices and dial-in connections. The speaker identification logic 132 is software that enables the conference server to identify that a participant is speaking, e.g., according to the techniques described in connection with FIGS. 1, 2 and 4. The location identification logic 133 is software that enables the conference server to identify when a participant is at a particular multi-participant location, e.g., according to the techniques described in connection with FIGS. 1-3.

Memory 130 may comprise read only memory (ROM), random access memory (RAM), magnetic disk storage media devices, optical storage media devices, flash memory devices, electrical, optical, or other physical/tangible memory storage devices. Processor 120 is, for example, a microprocessor or microcontroller that executes instructions for general logic 131, speaker identification logic 132 and location identification logic 133. Thus, in general, the memory 130 may comprise one or more tangible (non-transitory) computer readable storage media (e.g., a memory device) encoded with software comprising computer executable instructions and when the software is executed (by the processor 120) it is operable to perform the operations described herein in connection with general logic 131, speaker identification logic 132 and location identification logic 133.

In summary, a method is provided for automatically grouping and visually displaying conference attendees that are located in the same location (for example in a large conference room), and for identifying which particular user in the same room is actively speaking. However, the method is not limited to grouping and visually displaying conference attendees at one single location. Instead, it is also possible that multiple attendees in more than one conference room are participating in the online conference. Therefore, multiple locations and separate groups of attendees for each of these multiple locations may be created and visually displayed.

Other techniques are provided to solve the problem of poor audio quality experienced by remote users when multiple local users are co-located in the same room leveraging an in-room conference solution and some users are a distance away from the microphone connected to a dial-in phone.

To summarize, an online conference session that involves participants at multiple locations is established. It is determined that there are multiple participants of the online conference session at a first location at which one or more microphones connected to or integral with an in-room phone can detect audio from the multiple participants. A visual indicator of the first location is generated and in a predetermined relationship with the visual indicator of the first location, identifiers of the multiple participants at the first location are generated for display to participants in the online conference session.

When it is determined that there are multiple participants at the first location, audio captured by the one or more microphones connected to or integral with the in-room phone at the first location is received and audio captured by a microphone of a user device connected to the online conference session is compared with the audio captured by the one or more microphones connected to or integral with the in-room phone at the first location. When the audio received from the user device matches the audio captured by the one or more microphones connected to or integral with the in-room phone at the first location, it is determined that at least one participant associated with the user device is at the first location. The audio captured by the one or more microphones connected to or integral with the in-room phone at the first location may be received via a dial-in phone connection.

The comparing is performed on a continual basis with respect to audio received from user devices that connect to the online conference session in order to determine whether and when to add or delete an identifier of a participant at the first location. In addition, an indicator is generated for display in order to indicate which of the multiple participants at the first location is/are speaking at any point in time.

As a further variation, for a participant who is determined to be speaking at the first location, it is determined whether the best audio for the participant is from the one or more microphones connected to or integral with the in-room phone at the first location or the microphone of the user device of the participant. Then, an indicator is generated for display that indicates who is determined to be speaking.

While the system may detect audio from the microphone of the user device of the participant to determine that the participant is currently speaking, the system does not require that the audio from the user device is transmitted to the other conference attendees. Instead, the audio from the user device may only be used for the determination of who is currently speaking. In other words, the system may determine that the in-room microphones provide a better quality of audio and may use the in-room microphones for transmission of the audio to the other conference attendees, while still being able to indicate who exactly is speaking based on the audio from the user device.

In one form, one of a plurality of microphones at the first location is selected to be used by a speaking participant at the first location based on an audio quality. For a participant who is determined to be speaking at the first location, it is determined whether best audio for the participant is from the one or more microphones connected to or integral with the in-room phone at the first location or the microphone of the user device of the participant, and the audio from the microphone of the user device of the participant is used as an audio signal for the online conference session in lieu of the audio from the one or more microphones tied to the in-room audio conferencing system at the first location.

In still another form, a method is provided in which audio is captured by a microphone of a device of a new participant joining an online conference is sampled. The audio captured by the microphone of the device of the new participant is compared with audio received from a microphone at a first location via a dial-in phone connection to generate a comparison result, and the new participant is associated with the first location depending on the comparison result. When it is determined that the audio captured by the microphone of the device of the new participant does not match with the audio received from the microphone at the first location via the dial-in phone connection, an indication that the device of the new participant is in a location different from the first location is displayed to participants in the online conference session. When it is determined that the audio captured by the microphone of the device of the new participant matches with the audio received from the microphone at the first location via the dial-in phone connection and that a group of participants associated with the first location exists, the new participant is added to the group, and an indication that the device of the new participant is in the first location is displayed to participants in the online conference session.

Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
establishing an online conference session that involves participants at multiple locations;
determining that there are multiple participants of the online conference session at a first location at which one or more microphones connected to or integral with an in-room phone can detect audio from the multiple participants; and
generating for display to participants in the online conference session a visual indicator of the first location and in a predetermined relationship with the visual indicator of the first location, identifiers of the multiple participants at the first location.

2. The method of claim 1, wherein determining that there are multiple participants at the first location includes:
receiving audio captured by the one or more microphones at the first location;
comparing audio captured by a microphone of a user device connected to the online conference session with the audio captured by the one or more microphones connected to or integral with the in-room phone at the first location; and
when the audio received from the microphone of the user device matches the audio captured by the one or more microphones connected to or integral with the in-room phone at the first location, determining that at least one participant associated with the user device is at the first location.

3. The method of claim 2, wherein the audio captured by the one or more microphones connected to or integral with the in-room phone at the first location is received via a dial-in phone connection.

4. The method of claim 1, further comprising generating for display an indicator that indicates which of the multiple participants at the first location is/are speaking at any point in time.

5. The method of claim 4, further comprising:
for a participant who is determined to be speaking at the first location, determining whether the best audio for the participant is from the one or more microphones connected to or integral with the in-room phone at the first location or the microphone of the user device of the participant; and
generating for display the indicator that indicates which of the multiple participants at the first location is/are speaking.

6. The method of claim 4, further comprising:
for a participant who is determined to be speaking at the first location, determining whether best audio for the participant is from the one or more microphones at the first location or the microphone of the user device of the participant, and
using the audio from the microphone of the user device of the participant as an audio signal for the online conference session in lieu of the audio from the one or more microphones at the first location.

7. The method of claim 1, further comprising receiving a command to change display of a particular participant that is not displayed as being at the first location so that the particular participant is displayed as being at the first location.

8. One or more computer readable storage media encoded with software comprising computer executable instructions and when the software is executed operable to:
establish an online conference session that involves participants at multiple locations;
determine that there are multiple participants of the online conference session at a first location at which one or more microphones connected to or integral with an in-room phone can detect audio from the multiple participants; and
generate for display to participants in the online conference session a visual indicator of the first location and in a predetermined relationship with the visual indicator of the first location, identifiers of the multiple participants at the first location.

9. The computer readable storage media of claim 8, wherein the instructions operable to determine that there are multiple participants at the first location further comprise instructions operable to:
receive audio captured by the one or more microphones connected to or integral with the in-room phone at the first location;
compare audio captured by a microphone of a user device connected to the online conference session with the audio captured by the one or more microphones connected to or integral with the in-room phone at the first location; and
when the audio received from the microphone of the user device matches the audio captured by the one or more microphones connected to or integral with the in-room phone at the first location, determine that at least one participant associated with the user device is at the first location.

10. The computer readable storage media of claim 9, wherein the audio captured by the one or more microphones connected to or integral with the in-room phone at the first location is received via a dial-in phone connection.

11. The computer readable storage media of claim 8, further comprising instructions operable to generate for display an indicator that indicates which of the multiple participants at the first location is/are speaking at any point in time.

12. The computer readable storage media of claim 11, further comprising instructions operable to:
for a participant who is determined to be speaking at the first location, determine whether audio for the participant is from the one or more microphones connected to or integral with the in-room phone at the first location or the microphone of the user device of the participant; and
generate for display the indicator that indicates which of the multiple participants at the first location is/are speaking.

13. The computer readable storage media of claim 11, further comprising instructions operable to:
for a participant who is determined to be speaking at the first location, determine whether best audio for the participant is from the one or more microphones at the first location or the microphone of the user device of the participant, and
use the audio from the microphone of the user device of the participant as an audio signal for the online conference session in lieu of the audio from the one or more microphones at the first location.

14. The computer readable storage media of claim 8, further comprising instructions operable to receive a command to change display of a particular participant that is not displayed as being at the first location so that the particular participant is displayed as being at the first location.

15. An apparatus comprising:
one or more network interface units that enable network communication; and
a processor coupled to the one or more network interface units and the memory, wherein the processor:
establishes an online conference session that involves participants at multiple locations;
determine that there are multiple participants of the online conference session at a first location at which one or more microphones connected to or integral with an in-room phone can detect audio from the multiple participants; and
generates for display to participants in the online conference session a visual indicator of the first location and in a predetermined relationship with the visual indicator of the first location, identifiers of the multiple participants at the first location.

16. The apparatus of claim 15, wherein the processor:
receives audio captured by the one or more microphones at the first location;
compares audio captured by a microphone of a user device connected to the online conference session with the audio captured by the one or more microphones connected to or integral with the in-room phone at the first location; and
when the audio received from the microphone of the user device matches the audio captured by the one or more microphones connected to or integral with the in-room phone at the first location, determines that at least one participant associated with the user device is at the first location.

17. The apparatus of claim 16, wherein the audio captured by the one or more microphones connected to or integral with the in-room phone at the first location is received via a dial-in phone connection.

18. The apparatus of claim 16, wherein the processors compares the audio captured by the microphone of the user device on a continual basis with respect to audio received from user devices that connect to the online conference session in order to determine whether and when to add or delete an identifier of a participant at the first location.

19. The apparatus of claim 15, wherein the processor generates for display an indicator that indicates which of the multiple participants at the first location is/are speaking at any point in time.

20. The apparatus of claim 19, wherein the processor:
for a participant who is determined to be speaking at the first location, determines whether audio for the participant is from the one or more microphones connected to or integral with the in-room phone at the first location or the microphone of the user device of the participant; and
generates for display the indicator that indicates which of the multiple participants at the first location is/are speaking.

21. The apparatus of claim 19, wherein the processor:
for a participant who is determined to be speaking at the first location, determines whether best audio for the participant is from the one or more microphones at the first location or the microphone of the user device of the participant, and
uses the audio from the microphone of the user device of the participant as an audio signal for the online conference session in lieu of the audio from the one or more microphones at the first location.

22. The apparatus of claim 15, wherein the processor:
receives a command to change display of a particular participant that is not displayed as being at the first location so that the particular participant is displayed as being at the first location.
